(19) United States
(12) Patent Application Publication
(10) Pub. No.: US 2010/0009455 A1
(43) Pub. Date: Jan. 14, 2010

(54) Test Sensor with Under-Fill Protection

(76) Inventors: Andrew J. Dosmann, Granger, IN (US); Jason R. Diehl, Kendallville, IN (US)

Correspondence Address: NIXON PEABODY LLP, 300 S. Riverside Plaza, 16th Floor, CHICAGO, IL, 60606-6613, US

(21) Appl. No.: 12/226,968

(22) PCT Filed: May 3, 2007
(86) PCT No.: PCT/US2007/010613

§ 371 Date: May 19, 2009

Related U.S. Application Data
(60) Provisional application No. 60/798,488, filed on May 8, 2006.

(51) Int. Cl. G01N 21/00; G01N 31/22

(52) U.S. Cl. 436/164; 422/56

(57) ABSTRACT

A test sensor for testing an analyte concentration in a fluid sample includes a pre-fill capillary, formed by a base and a lid of the test sensor, and a sensing capillary. The pre-fill capillary is in fluid communication with the sensing capillary. The pre-fill capillary is first filled with the fluid sample and a portion of the fluid sample then moves by capillary action to the sensing capillary for testing of the analyte concentration.

### FIELD OF THE INVENTION

The present invention relates generally to test sensors adapted for determining an analyte concentration in a fluid sample, and more particularly, to test sensors having a sensing capillary and a pre-fill capillary adapted for protecting against insufficient sample volume.

### BACKGROUND OF THE INVENTION

It is often necessary to quickly obtain a sample of blood and perform an analysis of the blood sample. One example of a need for obtaining a sample of blood is in connection with a blood glucose monitoring system, which a user must frequently use to monitor the user's blood glucose level.

Those who have irregular blood glucose concentration levels are medically required to regularly self-monitor their blood glucose concentration level. An irregular blood glucose level can be brought on by a variety of reasons including illness such as diabetes. The purpose of monitoring the blood glucose concentration level is to determine the blood glucose concentration level and then to take corrective action, based upon whether the level is too high or too low, to bring the level back within a normal range. The failure to take corrective action can have serious implications. When blood glucose levels drop too low—a condition known as hypoglycemia—a person can become nervous, shaky, and confused. That person's judgment may become impaired and that person may eventually pass out. A person can also become very ill if their blood glucose level becomes too high—a condition known as hyperglycemia. Both conditions, hypoglycemia and hyperglycemia, are potentially life-threatening emergencies.

One method of monitoring a person's blood glucose level is with a portable, hand-held blood glucose testing device. The portable nature of these devices enables the users to conveniently test their blood glucose levels at anytime or in any place the user may be. The glucose testing device includes a test sensor to harvest the blood for analysis. In order to check the blood glucose level, a drop of blood is obtained from the fingertip using a lancing device. The blood drop is produced on the fingertip and the blood is harvested using the test sensor. The test sensor, which is inserted into a testing instrument, is brought into contact with the blood drop. The test sensor draws the blood to the inside of the testing instrument which then determines the concentration of glucose in the blood. Once the results of the test are displayed on a display of the testing instrument, the test sensor is discarded. Each new test requires a new test sensor.

As mentioned above, one problem associated with some lancing and/or testing devices is that the requisite amount of blood for accurate test results is not always obtained. Roughly thirty percent of lances do not produce enough blood for analysis. Furthermore, the amount of blood obtained from each lance varies. For most test sensors on the market, to obtain accurate test results, at least about 1 to 3 microliters of blood must be obtained. If less than this amount is obtained, the test results may be erroneous and a test sensor is wasted.

More serious an issue, however, is that the user may be relying on inaccurate results when an insufficient sample volume is harvested. Obviously, because of the serious nature of the medical issues involved, erroneous results are to be avoided. Accordingly, their exists a need for a test sensor having an underfill protection system that can insure that a correct blood sample volume has been obtained. Furthermore, to reduce the occurrence of insufficient sample volume, there is also a need for a test sensor that requires a smaller amount of blood without compromising the accuracy of the test results.

### SUMMARY OF THE INVENTION

A test sensor for measuring the concentration of an analyte in a fluid sample comprises a base, a lid and a pre-fill capillary formed by the connection of the base and the lid. The pre-fill capillary is adapted to receive the fluid sample from a test subject. The test sensor also comprises a sensing capillary located between the base and the lid. The sensing capillary is in fluid communication with the pre-fill capillary and is adapted to draw at least a portion of the fluid sample from the pre-fill capillary for testing by an analyte-testing instrument.

A method of determining a concentration of an analyte in a fluid sample with a test sensor comprises the acts of providing the test sensor having a pre-fill capillary and sensing capillary. The pre-fill capillary is adapted to receive the fluid sample from a test subject. The method further comprises collecting the fluid sample from the test subject via the pre-fill capillary, moving a portion of the fluid sample from the pre-fill capillary into the sensing capillary, wherein the sensing capillary is in fluid communication with the pre-fill capillary, and measuring the concentration of the analyte in the fluid sample.

A test sensor for measuring the concentration of an analyte in a fluid sample comprises a base, a lid and a sensing capillary located between the base and the lid. The sensing capillary has a volume that is less than about 150 nanoliters.

The above summary of the present invention is not intended to represent each embodiment, or every aspect, of the present invention. Additional features and benefits of the present invention will become apparent from the detailed description, figures, and claims set forth below.

### BRIEF DESCRIPTION OF THE FIGURES

Other objects and advantages of the invention will become apparent upon reading the following detailed description in conjunction with the drawings in which:

FIG. 1 is an exploded view of a test sensor according to one embodiment of the present invention.

FIG. 2 is a perspective view of the test sensor of FIG. 1 having a pre-fill capillary and sensing capillary.

FIG. 3 is a side view of an analyte testing instrument showing an alignment channel and illumination aperture.

### DETAILED DESCRIPTION OF THE ILLUSTRATED EMBODIMENTS

As discussed in the background section, test sensors are commonly used to measure the amount of glucose in a person's blood. The embodiments of the present invention described herein are described in reference to an optical test sensor. However, the present invention is not intended to be limited for use with optical test sensors, but is intended by be used in connection with other test sensors, such as electrochemical test sensors as described in commonly owned U.S. Pat. No. 5,759,364, which is incorporated herein by reference in its entirety, or colorimetric test sensors, which is described in commonly owned U.S. Pat. No. 5,723,284, which is incorporated herein by reference in its entirety.

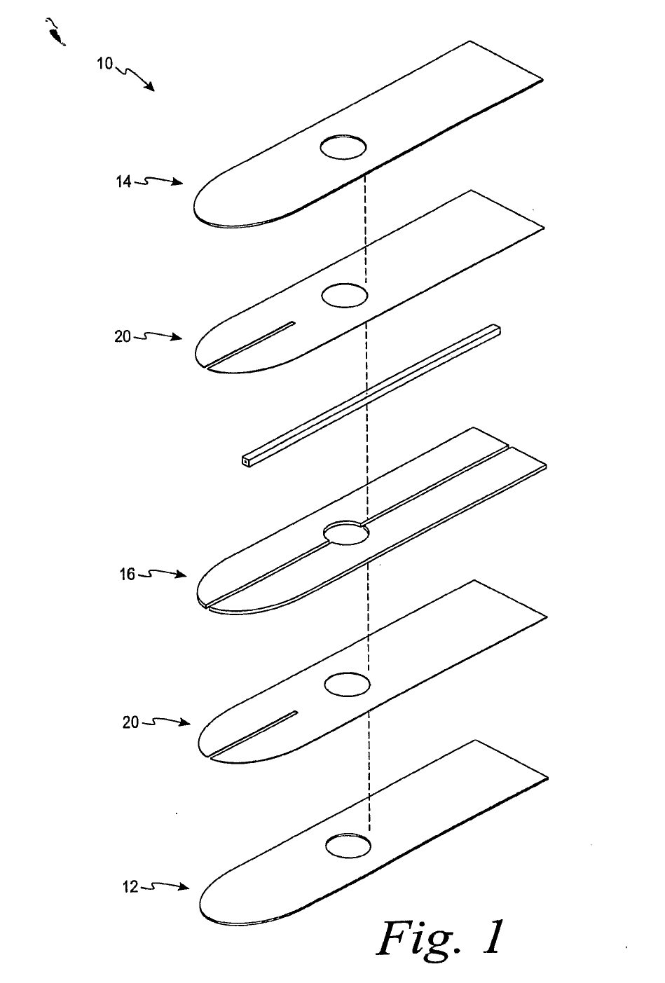

Referring now to FIG. 1, there is shown an exploded-view of a test sensor 10 according to one embodiment of the present invention. The test sensor 10 includes a base 12 and a lid 14. Also shown in the embodiment of FIG. 1 is a spacer 16. The base 12, the lid 14 and the spacer 16 may be connected by at least one adhesive 20, such as those commercially available from 3M, which may be applied to the base 12 and/or lid 14. In some embodiments, the base 12, the lid 14 and the spacer 16 may be connected using a thermally-active adhesive or a UV-curable adhesive. In other embodiments, the base 12, the lid 14 and the spacer 16 may be connected using an adhesive layer of glue or an adhesive layer attached to a substrate such that the substrate is removed after application to the base 12 or lid 14. Other modes of attachment known in the art are also contemplated by the present invention.

In some embodiments, the test sensor 10 may not include a spacer 16 as a separate component of the test sensor 10. Instead, the test sensor 10 may include a base 12 having a spacer that is an integrated component of the base 12 (not shown). In some of the embodiments of test sensors 10 described below which include a spacer 16, it is contemplated that these embodiments may instead include a spacer which has been integrated as part of the base 12.

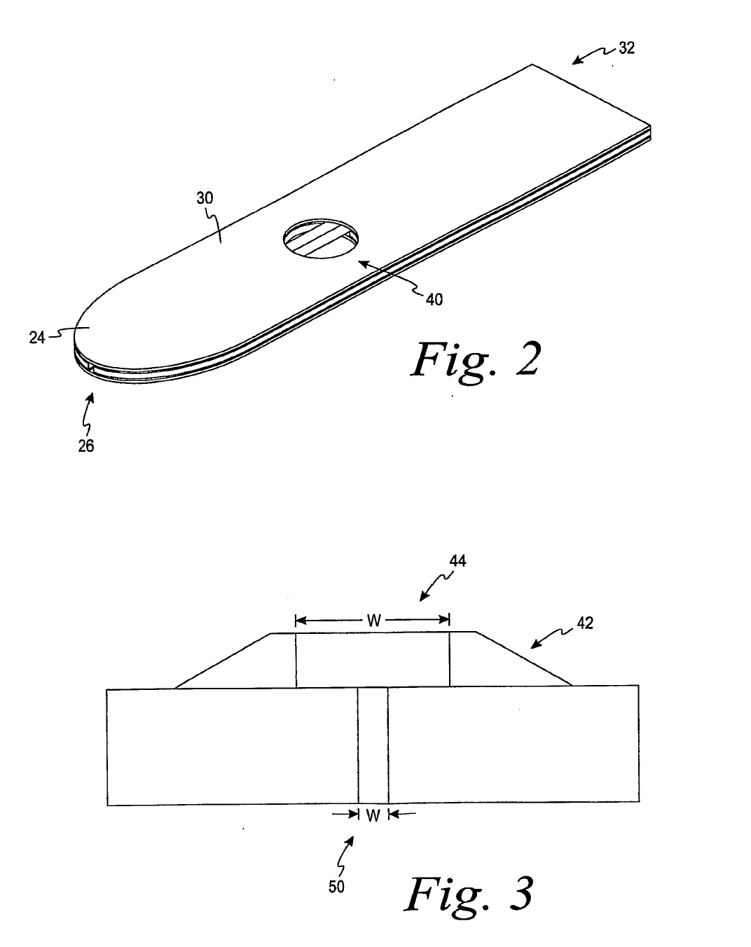

As described above, the base 12, the lid 14 and the spacer 16 may be connected by at least one adhesive 20. In some embodiments, shown in FIG. 2, the attachment of the base 12, the lid 14 and the spacer 16 forms a pre-fill capillary 24 at the fill end 26 of the test sensor 10. In other embodiments, the attachment of only the base 12 and the lid 14 form the pre-fill capillary 24. The dimensions of the pre-fill capillary 24 may range from about 250 μm to about 350 μm in height, from about 250 μm to about 350 μm in width and from about 3.2 mm to about 4.2 mm in length. A desirable size of the pre-fill capillary 24 of one embodiment of the present invention is about 300 μm in height by about 300 μm in width by about 3.7 mm in length. The volume of the pre-fill capillary 24 is therefore less than about 0.5 microliters, and desirably about 0.3 to 0.4 microliters.

The test sensor 10 also includes a sensing capillary 30 as shown in FIG. 2. The sensing capillary 30 is a separate part which is placed between the base 12 and the lid 14 at some distance from the fill end 26 of the test sensor 10. For example, the sensing capillary 30 may be placed about 3 mm to about 5 mm from the fill end 26 of the test sensor 10. In some embodiments, the sensing capillary 30 is placed about 3.7 mm from the end of fill end 26 of the test sensor 10. The inside dimensions of the sensing capillary 30 may range from about 140 μm to about 160 μm in width, from about 70 μm to about 80 μm in height and from about 8 mm to about 12 mm in length. A desirable size of the sensing capillary 30 of one embodiment of the present invention is about 150 μm in width by about 75 μm in height by about 10 mm in length. The volume of the sensing capillary 30 is therefore less than about 0.2 microliters, and desirably about 0.10 to about 0.15 microliters.

One end of the sensing capillary 30 (nearest the fill end 26) is in fluid communication with the pre-fill capillary 24. The opposite end of the sensing capillary 30 may be vented by a channel that extends from the back of the sensing capillary 30 to the vent end 32 of the test sensor 10. The vent channel is adapted to vent the sensing capillary as a fluid sample moves into the sensing capillary 30 and air is displaced.

Desirably, the combined volume of the pre-fill capillary 24 and the sensing is capillary 30 is less than about 450 nanoliters. In some embodiments, the combined volume of the pre-fill capillary 24 and the sensing capillary 30 may range from about 10 nanoliters to less than about 450 nanoliters. Desirably, the combined volume may range from about 150 nanoliters to less than about 450 nanoliters. The volume of the pre-fill capillary 24 may be about at least twice the volume of the sensing capillary 30, and desirably at least three times the volume of the sensing capillary 30.

The pre-fill capillary 24 is adapted to receive a fluid sample from a test subject. As described above in the Background section, the amount of fluid that is needed from a test subject to perform the testing is a critical factor in the accuracy of the analyte concentration reading. The pre-fill capillary 24 addresses the problem of inadequacy of sample size, know as sample under-fill. The pre-fill capillary 24 receives an amount of fluid sample that is greater than the amount of sample needed for proper testing of the sample that occurs via the sensing capillary 30. This is because the volume of the pre-fill capillary 24 is at least two times the volume of the sensing capillary 30.

Once the pre-fill capillary 24 is filled with the fluid sample, the sensing capillary 30 begins to receive a portion of the fluid sample from the pre-fill capillary 24 because the pre-fill capillary 24 and the sensing capillary 30 are in fluid communication. The sensing capillary 30 quickly fills with the fluid sample by capillary action until the fluid sample reaches the end of the sensing capillary 30 towards the vent end 32 of the test sensor 10. The movement of fluid from the pre-fill capillary 24 to the sensing capillary 30 stops when the fluid sample reaches the end of the sensing capillary 30 and the sensing capillary 30 is filled.

In operation, the test sensor 10 is installed in an analyte-testing instrument (not shown) with about 10 mm of the fill end 26 visible from the outside of the instrument. The test subject provides a fluid sample to the fill end 26 of the test sensor 10. To facilitate the filling of the pre-fill capillary 24 at the fill end 26 of the test sensor 10, the base 12 may be extended at the fill end 26 to form a lip to prevent blocking of the o end of the pre-fill capillary 24 by the finger of the test subject. If the fill end of the pre-fill capillary 24 is blocked, the pre-fill capillary 24 can not be filled with fluid sample.

To ensure that an adequate sample volume is obtained, a test subject may make multiple attempts at different time periods to fill the pre-fill capillary 24. For example, the test subject may make a first attempt to fill the pre-fill capillary 24 and then, a few seconds later, the test subject may make a second attempt to complete the filling of the pre-fill capillary 24. This ensures that an adequate sample volume is obtained before the sensing capillary 30 is filled. This under-fill protection of the sensing capillary 30 due to the filling of the pre-fill capillary 24 first reduces the chances of getting an erroneous test result or wasting a test sensor 10 because of insufficient sample volume.

Once an adequate sample volume has been obtained via the pre-fill capillary 24 and the sensing capillary 30, the test sensor 10 is ready for testing. Referring now to FIG. 3, the test sensor 10 of the present invention is positioned in an analyte-testing instrument using a strip guide (not shown) in the instrument that positions an alignment aperture 40 of the test sensor (shown in FIG. 1) over a raised conical dimple 42 molded into the strip guide of the instrument. The alignment aperture 40 is generally located near the fill end 26 of the test sensor 10. In some embodiments, the alignment aperture 40 is desirably located about 12 mm from the fill end 26 of the test sensor 10.

The conical dimple 42 guides the sensing capillary 30 into an alignment channel 44 of the analyte-testing instrument. The width of the alignment channel 44 is desirably about 320 μm. At this width, i.e., approximately 320 μm, the alignment channel 44 is larger than the outside width of the sensing capillary 30, i.e., about 300 μm.

Below the alignment channel 44 of the analyte-testing instrument is an illumination aperture 50. The illumination aperture 50 receives a beam of light from a light source of the analyte-testing instrument. Desirably, in one embodiment, the illumination aperture 50 is about 50 μm wide and about 2 mm long. Light passing through the illumination aperture 50 must be within the inside width of the sensing capillary 30, i.e, within about 150 μm. Alignment of the sensing capillary 30 within the illumination aperture 50 is an important factor in receiving accurate testing results. Misalignment may cause the edge of the sensing capillary 30 to interfere with the beam of light exiting the illumination aperture 50 and cause erroneous results.

A detection aperture (not shown) located within the analyte-testing instrument detects light as it is transmitted through the sensing capillary 30. Light transmitted through the sensing capillary 30 and fluid sample is used to determine the analyte concentration. The sending capillary 30 may be coated with a reagent and the analyte concentration can be determined by measuring the change in the optical properties of the analyte being tested. The change in optical properties is compared to calibration data previously obtained by similarly testing a calibration sample of known analyte concentration. Alternatively, the sensing capillary may not be coated with a reagent and the analyte concentration is determined by reading the amount of analyte directly at specific wavelengths.

One way of lowering the volume of the fluid sample that can be reliably analyzed is to improve the mechanical alignment tolerances between the test sensor 10 and the analyte-testing instrument. The worst-case combined mechanical alignment tolerances between the sensing capillary 30, the alignment channel 44 and the illumination aperture 50 is about +/−40 μm. This combined tolerance includes a tolerance of about +/−10 μm that accounts for clearance between the alignment channel 44 and the outside surface of the sensing capillary 30. Thus, alignment of the inside width of the sensing capillary 30, i.e., about 150 μm, to the width of the illumination aperture 50, i.e., about 50 μm, leaves about 50 μm per side of misalignment before the inside edge of the sensing capillary 30 interferes with the beam of light exiting the illumination aperture 50. Mechanical tolerances take about 40 μm per side of the clearance which leaves an additional 10 μm per side safety margin.

In addition to lower fluid sample volumes, smaller mechanical alignment tolerances improve analyte concentration precision performance. The only two parts s that contribute to the mechanical alignment tolerance between the test sensor 10 and the analyte-testing instrument are the sensing capillary 30 and the strip guide. The strip guide is precision micro-molded with a mechanical tolerance of only about +/−5 μm for each dimension. The strip guide is commercially available form Makuta Technics in Columbus, Ind.

The sensing capillary 30 can also be manufactured with a mechanical tolerance of only about +/−5 μm for each dimension. One type of sensing capillary 30 that may be used with the present invention may be made from synthetic fused quartz with a coat of transparent polyimide on the outside of the surfaces to prevent breakage. This type of sensing capillary is commercially available from Polymicro Technologies, LLC in Phoenix, Ariz.

The preferred inside path length through the sensing capillary 30 is about 75 μm, with a mechanical alignment tolerance of about +/−5 μm. Variation in path length is known to cause a proportional error in determining analyte concentration readings. A small +/−5 μm variation in path length reduces analyte concentration errors caused by path length to 6.66%, or a coefficient of variation (C.V.) of about 2.22%. Longer path lengths would reduce the path length error proportionally.

By having smaller fluid sample volume requirements, the overall size of the test sensor 10 can be reduced to about 1 mm to about 3 mm in width, about 7 mm to about 13 mm in length and about 0.25 mm to about 0.75 mm in depth. Desirably, the overall size of the test sensor 10 is about 2 mm wide by about 10 mm long by about 0.5 mm thick. Smaller test sensor sizes reduce the size of the analyte-testing instrument, particularly when the test sensors 10 are packaged in a cartridge. Smaller test sensor sizes reduce the material cost to manufacture the test sensors 10.

While the invention is susceptible to various modifications and alternative forms, specific embodiments thereof have been shown by way of example in the drawings and herein described in detail. It should be understood, however, that it is not intended to limit the invention to the particular forms disclosed, but on the contrary, the intention is to cover all modifications, equivalents, and alternatives falling within the spirit and scope of the invention as defined by the present embodiments.

### ALTERNATIVE EMBODIMENTS

### Alternative Embodiment A

A test sensor for measuring the concentration of an analyte in a fluid sample, the test sensor comprising:

a base and a lid;

a pre-fill capillary formed by the connection of the base and the lid, the pre-fill capillary adapted to receive the fluid sample from a test subject; and

a sensing capillary located between the base and the lid, the sensing capillary being in fluid communication with the pre-fill capillary and adapted for drawing at least a portion of the fluid sample from the pre-fill capillary for testing by an analyte-testing instrument.

### Alternative Embodiment B

The test sensor of alternative embodiment A, wherein the combined volume of the pre-fill capillary and the sensing capillary is less than about 450 nanoliters.

### Alternative Embodiment C

The test sensor of alternative embodiment B, wherein the combined volume of the pre-fill capillary and the sensing capillary is in the range of about 150 nanoliters to less than about 450 nanoliters.

### Alternative Embodiment D

The test sensor of alternative embodiment A, wherein the volume of the pre-fill capillary is greater than the volume of the sensing capillary.

### Alternative Embodiment E

The test sensor of alternative embodiment D, wherein the volume of the pre-fill capillary is at least two times greater than the volume of the sensing capillary.

### Alternative Embodiment F

The test sensor of alternative embodiment A, wherein the sensing capillary is adapted to be filled with the fluid sample from the pre-fill capillary by capillary action.

### Alternative Embodiment G

The test sensor of alternative embodiment F, wherein the pre-fill capillary is filled with the fluid sample before the sensing capillary begins to fill.

### Alternative Embodiment H

The test sensor of alternative embodiment A, wherein the connection of the base and the lid occurs via an adhesive.

### Alternative Embodiment I

The test sensor of alternative embodiment H, wherein the test sensor further comprises a spacer located between the base and the lid.

### Alternative Embodiment J

The test sensor of alternative embodiment A, wherein the test sensor further comprises an alignment aperture adapted for guiding the sensing capillary into an alignment channel of the analyte-testing instrument.

### Alternative Embodiment K

The test sensor of alternative embodiment J, wherein the width of the alignment channel is greater than the outside width of the sensing capillary.

### Alternative Embodiment L

The test sensor of alternative embodiment A, wherein the test sensor further comprises a lip at a first end of the test sensor to prevent the pre-fill capillary from being plugged while receiving the fluid sample.

### Alternative Embodiment M

The test sensor of alternative embodiment A, wherein the test sensor further comprises a vent at a second end of the test sensor for venting the sensing capillary.

### Alternative Process N

A method of determining a concentration of an analyte in a fluid sample with a test sensor, the method comprising the acts of:

providing the test sensor having a pre-fill capillary and sensing capillary, the pre-fill capillary adapted to receive the fluid sample from a test subject;

collecting the fluid sample from the test subject via the pre-fill capillary;

moving a portion of the fluid sample from the pre-fill capillary into the sensing capillary, the sensing capillary being in fluid communication with the pre-fill capillary; and

measuring the concentration of the analyte in the fluid sample.

### Alternative Process O

The method of alternative process N, wherein the act of collecting the fluid sample includes allowing the test subject to fill the pre-fill capillary at different times.

### Alternative Process P

The method of alternative process N, wherein the act of measuring the concentration of the analyte occurs by light transmission through the sensing capillary.

### Alternative Process Q

The method of alternative process N, wherein the combined volume of the pre-fill capillary and the sensing capillary is less than about 450 nanoliters.

### Alternative Process R

The method of alternative process Q, wherein the combined volume of the to pre-fill capillary and the sensing capillary is in the range of about 150 nanoliters to less than about 450 nanoliters.

### Alternative Process S

The method of alternative process N, wherein the volume of the pre-fill capillary is greater than the volume of the sensing capillary.

### Alternative Process T

The method of alternative process S, wherein the volume of the pre-fill capillary is at least two times greater than the volume of the sensing capillary.

### Alternative Process U

The method of alternative process N, further comprising guiding the test sensor into an alignment channel of an analyte-testing instrument via an alignment aperture in the test sensor.

### Alternative Process V

The method of alternative process N, wherein the act of collecting the fluid sample via the pre-fill capillary comprises providing a lip at a first end of the test sensor to prevent the pre-fill capillary from being plugged while receiving the fluid sample.

### Alternative Embodiment W

A test sensor for measuring the concentration of an analyte in a fluid sample, the test sensor comprising:

a base and a lid; and

a sensing capillary located between the base and the lid, the sensing capillary having a volume that is less than about 150 nanoliters.

### Alternative Embodiment X

The test sensor of alternative embodiment W, wherein the sensing capillary is made from synthetic fused quartz.

### Alternative Embodiment Y

The test sensor of alternative embodiment W, wherein the sensing capillary includes a coat of transparent polyimide on the outside surface of the sensing capillary to prevent breakage.

1. A test sensor for measuring the concentration of an analyte in a fluid sample, the test sensor comprising:
a base and a lid;
a pre-fill capillary formed by the connection of the base and the lid, the pre-fill capillary adapted to receive the fluid sample from a test subject; and
a sensing capillary located between the base and the lid, the sensing capillary being in fluid communication with the pre-fill capillary and adapted for drawing at least a portion of the fluid sample from the pre-fill capillary for testing by an analyte-testing instrument.

2. The test sensor of claim 1, wherein the combined volume of the pre-fill capillary and the sensing capillary is less than about 450 nanoliters.

3. The test sensor of claim 2, wherein the combined volume of the pre-fill capillary and the sensing capillary is in the range of about 150 nanoliters to less than about 450 nanoliters.

4. The test sensor of claim 1, wherein the volume of the pre-fill capillary is greater than the volume of the sensing capillary.

5. The test sensor of claim 4, wherein the volume of the pre-fill capillary is at least two times greater than the volume of the sensing capillary.

6. The test sensor of claim 1, wherein the sensing capillary is adapted to be filled with the fluid sample from the pre-fill capillary by capillary action.

7. The test sensor of claim 6, wherein the pre-fill capillary is filled with the fluid sample before the sensing capillary begins to fill.

8. The test sensor of claim 1, wherein the connection of the base and the lid occurs via an adhesive.

9. The test sensor of claim 1, wherein the test sensor further comprises a spacer located between the base and the lid.

10. The test sensor of claim 1, wherein the test sensor further comprises an alignment aperture adapted for guiding the sensing capillary into an alignment channel of the analyte-testing instrument.

11. The test sensor of claim 10, wherein the width of the alignment channel is greater than the outside width of the sensing capillary.

12. The test sensor of claim 1, wherein the test sensor further comprises a lip at a first end of the test sensor to prevent the pre-fill capillary from being plugged while receiving the fluid sample.

13. The test sensor of claim 1, wherein the test sensor further comprises a vent at a second end of the test sensor for venting the sensing capillary.

14. A method of determining a concentration of an analyte in a fluid sample with a test sensor, the method comprising the acts of:
providing the test sensor having a pre-fill capillary and sensing capillary, the pre-fill capillary adapted to receive the fluid sample from a test subject;
collecting the fluid sample from the test subject via the pre-fill capillary;
moving a portion of the fluid sample from the pre-fill capillary into the sensing capillary, the sensing capillary being in fluid communication with the pre-fill capillary; and
measuring the concentration of the analyte in the fluid sample.

15. The method of claim 14, wherein the act of collecting the fluid sample includes allowing the test subject to fill the pre-fill capillary at different times.

16. The method of claim 14, wherein the act of measuring the concentration of the analyte occurs by light transmission through the sensing capillary.

17. The method of claim 14, wherein the combined volume of the pre-fill capillary and the sensing capillary is less than about 450 nanoliters.

18. The method of claim 17, wherein the combined volume of the pre-fill capillary and the sensing capillary is in the range of about 150 nanoliters to less than about 450 nanoliters.

19. The method of claim 14, wherein the volume of the pre-fill capillary is greater than the volume of the sensing capillary.

20. The method of claim 19, wherein the volume of the pre-fill capillary is at least two times greater than the volume of the sensing capillary.

21. The method of claim 14, further comprising guiding the test sensor into an alignment channel of an analyte-testing instrument via an alignment aperture in the test sensor.

22. The method of claim 14, wherein the act of collecting the fluid sample via the pre-fill capillary comprises providing a lip at a first end of the test sensor to prevent the pre-fill capillary from being plugged while receiving the fluid sample.

23. A test sensor for measuring the concentration of an analyte in a fluid sample, the test sensor comprising:
a base and a lid; and
a sensing capillary located between the base and the lid, the sensing capillary having a volume that is less than about 150 nanoliters.

24. The test sensor of claim 23, wherein the sensing capillary is made from synthetic fused quartz.

25. The test sensor of claim 23, wherein the sensing capillary includes a coat of transparent polyimide on the outside surface of the sensing capillary to prevent breakage.
